(19) United States
(12) Patent Application Publication
(10) Pub. No.: US 2024/0340750 A1
(43) Pub. Date: Oct. 10, 2024

(54) APPARATUS AND METHOD FOR CELL RESELECTION IN A WIRELESS COMMUNICATION SYSTEM

(71) Applicant: Samsung Electronics Co., Ltd., Suwon-si (KR)

(72) Inventors: Yanze FU, Beijing (CN); Haijie QIU, Beijing (CN)

(21) Appl. No.: 18/629,750

(22) Filed: Apr. 8, 2024

(30) Foreign Application Priority Data
Apr. 7, 2023 (CN) 202310370585.5

(51) Int. Cl. H04W 36/32; H04W 36/00; H04W 36/08

(52) U.S. Cl. CPC H04W 36/322; H04W 36/0058; H04W 36/08

(57) ABSTRACT

The disclosure relates to a 5G or 6G communication system for supporting a higher data transmission rate. The present application provides methods performed by a terminal and a base station in a wireless communication system, a terminal, and a base station. In an aspect, a method performed by a terminal in a wireless communication system includes: receiving first information from a base station of a serving cell of a first type, the first information includes location-related information of the serving cell and information of a neighbouring cell of a second type; and measuring the neighbouring cell of the second type based on a UE location and the location-related information of the serving cell.

### CROSS-REFERENCE TO RELATED APPLICATION

This application is based on and claims priority under 35 U.S.C. § 119 to Chinese Patent Application No. 202310370585.5 filed on Apr. 7, 2023, in the Chinese Intellectual Property Office, the disclosure of which is incorporated by reference herein in its entirety.

### BACKGROUND

### 1. Field

The present application generally relates to the field of a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4^{th} generation (4G) communication systems, efforts have been made to develop improved 5G or pre-5G communication systems. Therefore, 5G or pre-5G communication systems are also called “Beyond 4G networks” or “Post-LTE systems.”

In order to achieve a higher data rate, 5G communication systems are implemented in higher frequency (millimeter, mmWave) bands, e.g., 60 GHz bands. In order to reduce propagation loss of radio waves and increase transmission distance thereof, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments for system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, or the like.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### SUMMARY

According to an aspect of the present disclosure, a method performed by a user equipment UE in a wireless communication system is provided. The method may include: receiving first information from a base station of a serving cell of a first type, the first information may include location-related information of the serving cell and information of a neighbouring cell of a second type; and measuring the neighbouring cell of the second type based on a UE location and the location-related information of the serving cell.

In some embodiments, in the method performed by the UE, the first information may further include: information of a neighbouring cell of the first type.

In some embodiments, the method performed by the UE may further include: measuring the neighbouring cell of the first type; reselecting a cell according to a measurement result of the neighbouring cell of the first type and a measurement result of the neighbouring cell of the second type.

In some embodiments, in the method performed by the UE, the location-related information of the serving cell may include: a reference location of the serving cell. The measuring the neighbouring cell of the second type based on the UE location and the location-related information of the serving cell may include: determining whether to measure the neighbouring cell of the second type based on a distance from the UE location to the reference location of the serving cell.

In some embodiments, in the method performed by the UE, the first information may further include: location-related information of the neighbouring cell of the second type. The measuring the neighbouring cell of the second type based on the UE location and the location-related information of the serving cell may include: measuring the neighbouring cell of the second type based on the UE location, the location-related information of the serving cell, and the location-related information of the neighbouring cell of the second type.

In some embodiments, in the method performed by the UE, the location-related information of the serving cell may include: a reference location of the serving cell; and the location-related information of the neighbouring cell of the second type includes: a reference location of the neighbouring cell of the second type.

In some embodiments, in the method performed by the UE, the measuring the neighbouring cell of the second type based on the UE location and the location-related information of the serving cell may include: determining whether to measure the neighbouring cell of the second type based on a distance from the UE location to the reference location of the serving cell, and a distance from the reference location of the serving cell to the reference location of the neighbouring cell of the second type.

In some embodiments, in the method performed by the UE, the location-related information of the serving cell may include: a reference location of the serving cell; and the location-related information of the neighbouring cell of the second type may include: a reference location and coverage range information of the neighbouring cell of the second type.

In some embodiments, in the method performed by the UE, the method may further include: determining whether to measure the neighbouring cell of the second type based on a distance from the UE location to the reference location of the serving cell, a distance from the reference location of the serving cell to the reference location of the neighbouring cell of the second type, and the coverage range information of the neighbouring cell of the second type.

In some embodiments, in the method performed by the UE, the first information may further include: priority-related information and a cell type. The method may further include: measuring a neighbouring cell of the cell type based on the priority-related information.

In some embodiments, in the method performed by the UE, the first information may further include: an RSRP difference threshold and/or an RSRQ difference threshold. The method may further include: re-selecting a cell based on the RSRP difference threshold and/or the RSRQ difference threshold.

In some embodiments, in the method performed by the UE, the measuring the neighbouring cell of the second type may include: measuring the neighbouring cell of the second type based on a first time, the first time is determined based on at least one of a measurement time, a detection time and an evaluation time, the at least one of the measurement time, the detection time and the evaluation time is determined based on the location-related information of the serving cell and the location-related information of the neighbouring cell of the second type.

According to another aspect of the present disclosure, a method performed by a base station in a wireless communication system is provided. The method may include: transmitting first information to a user equipment UE from a serving cell of a first type, the first information includes location-related information of the serving cell and information of a neighbouring cell of a second type; and receiving an uplink transmission signaling from the UE, the location-related information of the serving cell is used for measurement of the neighbouring cell of the second type.

In some embodiments, in the method performed by the base station, the first information further includes: information of a neighbouring cell of the first type; and the method further includes: a measurement result of the neighbouring cell of the first type and a measurement result of the neighbouring cell of the second type are used for a reselection of a cell.

In some embodiments, in the method performed by the base station, the location-related information of the serving cell includes: a reference location of the serving cell; wherein the reference location of the serving cell is used for the measurement of the neighbouring cell of the second type.

In some embodiments, in the method performed by the base station, the first information further includes: a location-related information of the neighbouring cell of the second type; and the location-related information of the neighbouring cell of the second type is used for the measurement of the neighbouring cell of the second type.

In some embodiments, in the method performed by the base station, the location-related information of the serving cell includes: a reference location of the serving cell; the location-related information of the neighbouring cell of the second type: a reference location of the neighbouring cell of the second type; and the reference location of the serving cell and the reference location of the neighbouring cell of the second type are used for measurement of the neighbouring cell of the second type.

In some embodiments, in the method performed by the base station, the location-related information of the serving cell includes: a reference location of the serving cell; the location-related information of the neighbouring cell of the second type: a reference location and coverage range information of the neighbouring cell of the second type; and the reference location of the serving cell, the reference location and the coverage range information of the neighbouring cell of the second type are used for measurement of the neighbouring cell of the second type.

In some embodiments, in the method performed by the base station, the first information further includes priority-related information and a cell type; and the priority-related information is used for measurement of a neighbouring cell of the cell type.

In some embodiments, in the method performed by the base station, the first information further includes: an RSRP difference threshold and/or an RSRQ difference threshold; the RSRP difference threshold and/or the RSRQ difference threshold is used for a reselection of a cell.

In some embodiments, in the method performed by the base station, the first time is used for measurement of the neighbouring cell of the second type; the first time is determined based on at least one of a measurement time, a detection time and an evaluation time, the at least one of the measurement time, the detection time and the evaluation time is determined based on the location-related information of the serving cell and the location-related information of the neighbouring cell of the second type.

According to yet another aspect of the present disclosure, a user equipment UE is provided, the UE may include: a transceiver for transmitting and receiving signals; and a controller coupled to the transceiver and configured to perform the method performed by the UE as described above.

According to yet another aspect of the present disclosure, a base station is provided, the base station may include: a transceiver for transmitting and receiving signals; and a controller coupled to the transceiver and configured to perform the method performed by the base station as described above.

According to yet another aspect of the present disclosure, a computer-readable medium with instructions stored thereon is provided, the instructions, when executed by a controller or processor, cause the controller or the processor to perform the steps of the method perform by the UE and/or the base station as described above.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION

For a more complete understanding of the present disclosure and its advantages, reference is now made to the following description taken in conjunction with the accompanying drawings, in which like reference numerals represent like parts:

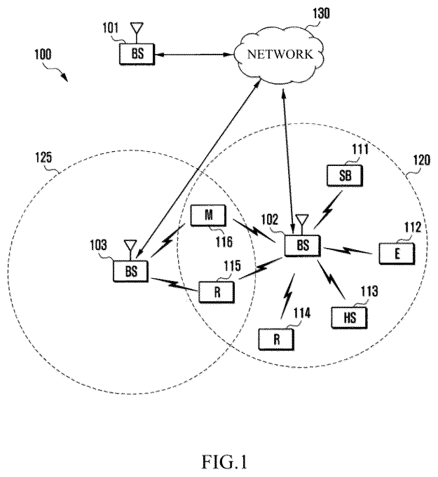

FIG. 1 illustrates an example of a wireless network according to various embodiments of the present disclosure;

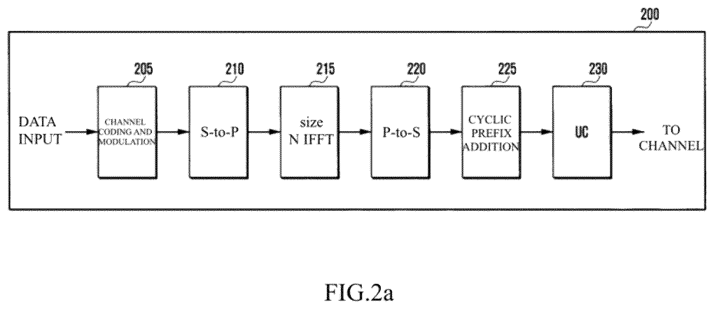

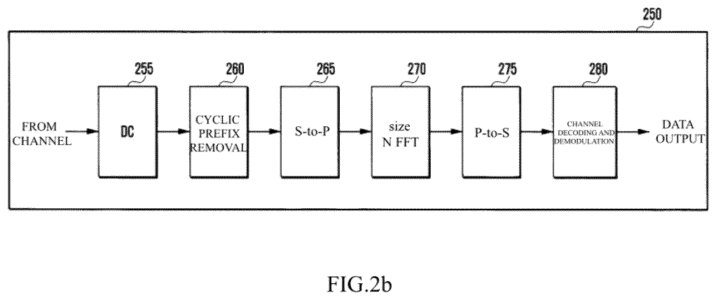

FIG. 2a illustrates examples of wireless transmission and reception paths according to various embodiments of the present disclosure;

FIG. 2b illustrates examples of wireless transmission and reception paths according to various embodiments of the present disclosure;

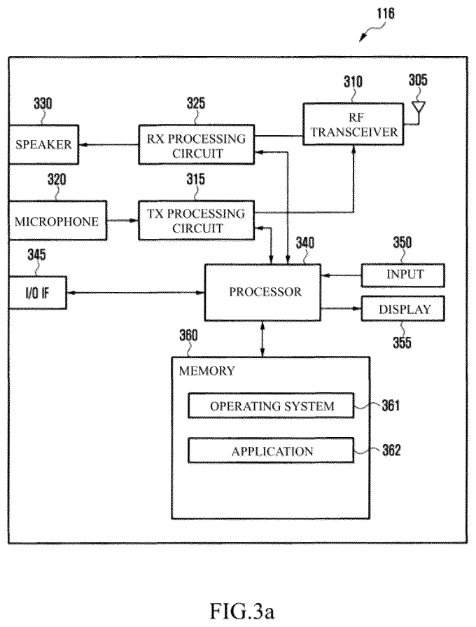

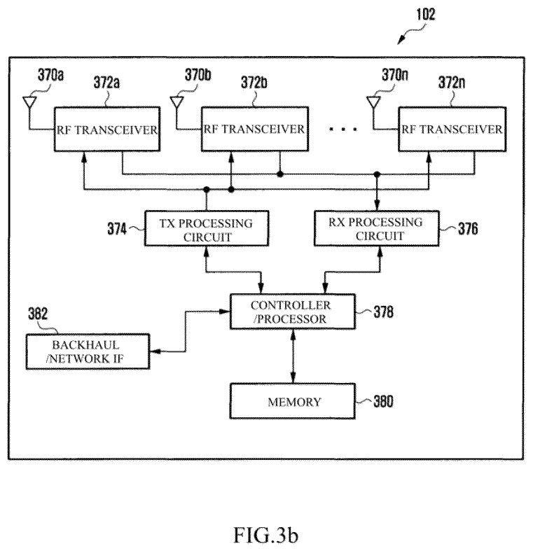

FIG. 3a illustrates an example of a UE according to various embodiments of the present disclosure;

FIG. 3b illustrates an example of a gNB according to various embodiments of the present disclosure;

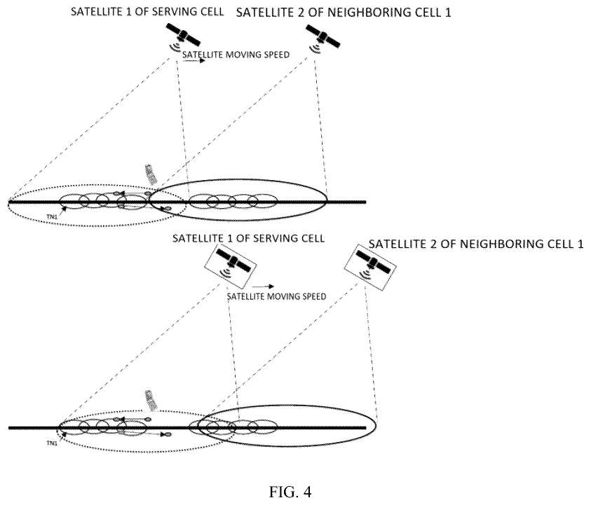

FIG. 4 illustrates an example of a cell reselection in a convergence network according to various embodiments of the present disclosure;

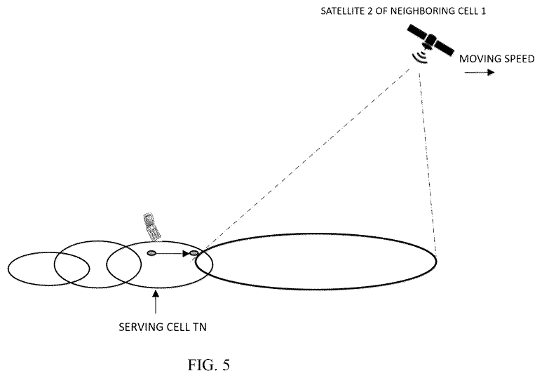

FIG. 5 illustrates another example of a cell reselection in a convergence network according to various embodiments of the present disclosure; and

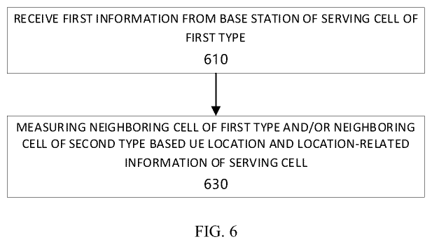

FIG. 6 illustrates a flowchart of a UE for performing cell reselection in a convergence network according to various embodiments of the present disclosure.

### DETAILED DESCRIPTION

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. In addition, the terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

FIG. 1 illustrates an example of a wireless network 100 according to various embodiments of disclosure. The embodiment of the wireless network 100 shown in FIG. 1 is for illustration only. Other embodiments of the wireless network 100 may be used without departing from the scope of this disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on the type of the network, other well-known terms such as “base station” or “access point” may be used instead of “gNodeB” or “gNB.” For convenience, the terms “gNodeB” and “gNB” are used herein to refer to a network infrastructure component that provides wireless access for remote terminals. In addition, depending on the type of the network, other well-known terms such as “mobile station,” “user station,” “remote terminal,” “wireless terminal,” or “user apparatus” may be used instead of “user equipment” or “UE.” For convenience, the terms “user equipment” and “UE” are used herein to refer to a remote wireless devices that wirelessly accesses the gNB, no matter whether the UE is a mobile device (such as a mobile phone or a smart phone) or a normal fixed device (such as a desktop computer or a vending machine).

The gNB 102 provides wireless broadband access to the network 130 for a first plurality of user equipments (UE) within a coverage area 120 of the gNB 102. The first plurality of UEs include: a UE 111, which may be located in a small business (SB); a UE 112, which may be located in an enterprise (E); a UE 113, which may be located in a Wi-Fi hotspot (HS); a UE 114, which may be located in a first residence (R); a UE 115, which may be located in a second residence (R); a UE 116, which may be a mobile device (M), such as a cellular phone, a wireless laptop computer, a wireless PDA, or the like. The gNB 103 provides wireless broadband access to network 130 for a second plurality of UE within a coverage area 125 of the gNB 103. The second plurality of UEs include a UE 115 and a UE 116. In some embodiments, one or more of the gNBs 101-103 may communicate with each other and with the UEs 111-116 by using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a 2D antenna array as described in embodiments of this disclosure. In some embodiments, one or more of the gNB 101, the gNB 102, and the gNB 103 support codebook designs and structures for systems with 2D antenna arrays.

Although FIG. 1 illustrates an example of the wireless network 100, various changes may be made to FIG. 1. For example, the wireless network 100 may include any number of gNBs and any number of UEs in any suitable arrangement. Furthermore, the gNB 101 may directly communicate with any number of UEs and provide wireless broadband access to the network 130 for those UEs. Similarly, each of the gNB 102-103 may directly communicate with the network 130 and provide direct wireless broadband access to the network 130 for the UEs. In addition, the gNBs 101, 102 and/or 103 may provide access to other or additional external networks, such as external telephone networks or other types of data networks.

FIGS. 2a and 2b illustrate examples of wireless transmission and reception paths according to various embodiment of the present disclosure. In the following description, a transmission path 200 may be described as being embodied in a gNB, such as the gNB 102, and a reception path 250 may be described as being embodied in a UE, such as the UE 116. However, it should be understood that the reception path 250 may be embodied in a gNB and the transmission path 200 may be embodied in a UE. In some embodiments, the reception path 250 is configured to support codebook designs and structures for systems with 2D antenna arrays as described in embodiments of this disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time-domain output signal. The parallel-to-serial block 220 converts (such as multiplexes) parallel time-domain output symbols from the size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. It may also filter the signal at a baseband before converting to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signals into a sequence of modulated data symbols. The channel decoding and demodulation block 280 demodulates and decodes the modulated symbols to recover the original input data stream.

Each of the gNBs 101-103 may implement a transmission path 200 similar to that for transmitting to the UEs 111-116 in a downlink, and may implement a reception path 250 similar to that for receiving from the UEs 111-116 in an uplink. Similarly, each of the UEs 111-116 may implement a transmission path 200 for transmitting to the gNBs 101-103 in an uplink, and may implement a reception path 250 for receiving from the gNBs 101-103 in a downlink.

Each of the components in FIGS. 2a and 2b may be embodied in only hardware, or in a combination of hardware and software/firmware. As a specific example, at least some of the components in FIGS. 2a and 2b may be embodied in software, while other components may be embodied in configurable hardware or a combination of software and configurable hardware. For example, the FFT block 270 and IFFT block 215 may be embodied as configurable software algorithms, in which the value of the size N may be modified according to the implementation.

Furthermore, although described as using FFT and IFFT, this is only illustrative and should not be interpreted as limiting the scope of this disclosure. Other types of transforms may be used, such as discrete Fourier transform (DFT) and inverse discrete Fourier transform (IDFT) functions. It should be understood that for DFT and IDFT functions, the value of variable N may be any integer (such as 1, 2, 3, and 4), while for FFT and IFFT functions, the value of variable N may be any integer which is a power of 2 (such as 1, 2, 4, 8, and 16).

Although FIGS. 2a and 2b illustrate examples of wireless transmission and reception paths, various changes may be made to FIGS. 2a and 2b. For example, various components in FIGS. 2a and 2b may be combined, further subdivided or omitted, and additional components may be added according to specific requirements. Furthermore, FIGS. 2a and 2b are intended to illustrate examples of types of transmission and reception paths that can be used in a wireless network. Any other suitable architecture may be used to support wireless communication in a wireless network.

FIG. 3a illustrates an example of a UE 116 according to various embodiments of the present disclosure. The embodiment of the UE 116 shown in FIG. 3a is for illustration only, and the UEs 111-115 of FIG. 1 may have the same or similar configuration. However, a UE has various configurations, and FIG. 3a does not limit the scope of this disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to the speaker 330 (such as for voice data) or to the processor/controller 340 for further processing (such as for web browsing data).

The TX processing circuit 315 receives analog or digital voice data from the microphone 320 or other outgoing baseband data (such as network data, email or interactive video game data) from the processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of this disclosure. The processor/controller 340 can move data into or out of the memory 360 as required by an execution process. In some embodiments, the processor/controller 340 is configured to execute the application 362 based on the OS 361 or in response to signals received from the gNB or the carrier. The processor/controller 340 is also coupled to the I/O interface 345, where the I/O interface 345 provides the UE 116 with the capability to connect to other devices such as laptop computers and handheld computers. The I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or another display capable of presenting text and/or at least limited graphics (such as from a website). The memory 360 is coupled to the processor/controller 340. A part of the memory 360 may include a random access memory (RAM), while another part of the memory 360 may include a flash memory or another read-only memory (ROM).

Although FIG. 3a illustrates an example of the UE 116, various changes may be made to FIG. 3a. For example, various components in FIG. 3a may be combined, further subdivided or omitted, and additional components may be added according to specific requirements. As a specific example, the processor/controller 340 may be divided into a plurality of processors, such as one or more central processing units (CPU) and one or more graphics processing units (GPU). Furthermore, although FIG. 3a illustrates that the UE 116 is configured as a mobile phone or a smart phone, the UEs may be configured to operate as other types of mobile or fixed devices.

FIG. 3b illustrates an example of a gNB 102 according to various embodiments of the present disclosure. The embodiment of the gNB 102 shown in FIG. 3b is for illustration only, and other gNBs of FIG. 1 may have the same or similar configuration. However, a gNB has various configurations, and FIG. 3b does not limit the scope of this disclosure to any specific implementation of a gNB. It should be noted that the gNB 101 and the gNB 103 may include the same or similar structures as the gNB 102.

As shown in FIG. 3b, the gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

The RF transceivers 372a-372n receive an incoming RF signal from the antennas 370a-370n, such as a signal transmitted by a UE or another gNB. The RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to the controller/processor 378 for further processing.

The TX processing circuit 374 receives analog or digital data (such as voice data, network data, email or interactive video game data) from the controller/processor 378. The TX processing circuit 374 encodes, multiplexes and/or digitizes outgoing baseband data to generate a processed baseband or IF signal. The RF transceivers 372a-372n receive the outgoing processed baseband or IF signal from the TX processing circuit 374 and up-convert the baseband or IF signal into an RF signal transmitted via the antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of this disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is embodied as a part of a cellular communication system, such as a cellular communication system supporting 5G or new radio access technology or NR, LTE or LTE-A, the backhaul or network interface 382 may allow the gNB 102 to communicate with other gNBs through wired or wireless backhaul connections. When the gNB 102 is embodied as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of the gNB 102 (embodied by using the RF transceivers 372a-372n, the TX processing circuit 374 and/or the RX processing circuit 376) support aggregated communication with FDD cells and TDD cells.

Although FIG. 3b illustrates an example of gNB 102, various changes may be made to FIG. 3b. For example, the gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

Exemplary embodiments of the present disclosure are further described below with reference to the accompanying drawings.

The text and drawings are provided as examples only to help readers understand this disclosure. They are not intended and should not be interpreted as limiting the scope of this disclosure in any way. Although certain embodiments and examples have been provided, based on the disclosure herein, it will be apparent to those skilled in the art that changes may be made to the illustrated embodiments and examples without departing from the scope of the present disclosure.

The technical solution of the embodiments of the present application may be applied to various communication systems, for example, a global system for mobile communications (GSM), a code division multiple access (CDMA) system, a wideband code division multiple access (WCDMA) system, a general packet radio service (GPRS) system, a long term evolution (LTE) system, an LTE frequency division duplex (FDD) system, an LTE time division duplex (TDD) system, a universal mobile telecommunication system (UMTS), a worldwide interoperability for microwave access (WiMAX) communication system, a 5^{th} generation (5G) system or a new radio (NR) system, or the like. Furthermore, the technical solution of the embodiments of the present application may be applied to future communication technologies.

With the development of 5G systems, in order to provide users with better communication services, such as providing communication services at any place at any time, especially in scenarios with coverage areas such as mountains, oceans, deserts, and the like, the support of satellite communication systems has been introduced into the 5G communication system due to the advantages of longer communication distance and larger coverage area. In the standard TR 3GPP 38.811, according to the type and orbital altitude of satellites, the satellite communication system may be divided into synchronous orbit or Geostationary Earth Orbit (referred to as GEO) satellite communication systems, and non-synchronous orbit or non-geostationary satellite communication systems. Non-synchronous orbit satellite communication systems, based on the orbital altitude of satellites, may be divided into medium Earth orbit (MEO) (referred to as medium orbit for short) satellite communication systems and low Earth orbit (LEO) (referred to as low orbit for short) satellite communication systems. The embodiments of the present disclosure relate to a method and a device for performing cell measurement of a convergence network in a communication system. In the present disclosure, cells of a convergence network include cells of different types of network, such as, but not limited to, terrestrial network cells, non-terrestrial network cells, macro cells, micro cells, or the like.

When a user equipment (UE) is in an idle (RRC_IDLE) state or an inactive (RRC_INACTIVE) state, the UE may reselect and camp on a more suitable cell through a cell reselection process.

The specific process of cell reselection performed by a UE is as follows.

The UE may measure a synchronization signal-reference signal received power (SS-RSRP) and/or synchronization signal-reference signal received quality (SS-RSRQ) of a serving cell for at least once every M1*N1 discontinuous reception cycles (DRX), and evaluate whether the serving cell meets a predetermined criteria. If the UE evaluates that within Nserv consecutive DRX cycles, the serving cell does not fulfill the predetermined criteria, the UE may initiate measurement of all neighbouring cells, regardless of current measurement rules that restrict the UE. The neighbouring cell measurements include intra-frequency measurements and inter-frequency measurements.

Wherein M1=1, 2 or other values. M1 is determined based on a mapping table of a synchronization signal block measurement timing configuration (e.g., SSB measurement timing configuration (SMTC)) and/or the DRX cycle. N1 is a scaling factor, determined based on the frequency range and/or terminal type or terminal antenna type mapping table. Nserv is determined based on a mapping table of M1 and/or N1.

In a communication system, a specific process for a cell measurement and reselection process for a convergence network includes:

A base station (e.g., a base station of a serving cell) periodically transmits information, for example, transmitting this information through a system information block, broadcasting information, or the like, and in addition to parameters of traditional technologies, the information may include at least one of the following:
a serving cell type (for example, a terrestrial network or a non-terrestrial network);
a neighbouring cell list group (each cell group includes at least one neighbouring cell and, for each neighbouring cell, a neighbouring cell list includes at least one of the following related to the corresponding neighbouring cell: a cell ID, frequency information, a priority, a reference location and a cell radius of each cell within the neighbouring cell group. For example, group 1 is a terrestrial network cell group, and group 2 is a non-terrestrial network cell group. If a cell belongs to a non-terrestrial network cell group, then the neighbouring cell further includes a cell beam type. Optionally, if the serving cell is a terrestrial network and the neighbouring cell list group includes a non-terrestrial network cell group, then the neighbouring cell list further includes a reference location and/or time information of the reference location and a second distance threshold of each neighbouring cell, wherein the time information may be determined based on the beam type of the neighbouring cell);
a reference location and/or time information of the reference location of the serving cell and/or neighbouring cell, including at least a distance threshold of the serving cell (a first distance threshold), which is a threshold that does not require to perform the measurement of a neighbouring cell, and optionally, a third distance threshold (a distance threshold for a relaxed measurement mode), in one embodiment, a distance threshold list may be a new distance threshold list, and in the another embodiment, the distance threshold list may be a reused distance threshold list;
A cell stop time of the serving cell for a coverage area;
optionally, a coverage area (and/or coverage range) size of the serving cell, such as a cell radius or a beam coverage area diameter;
a list of RSRP thresholds and/or RSRQ thresholds for the serving cell
a group priority;
optionally, a time interval of T_{duration}, if the serving cell is a non-terrestrial network and the neighbouring cell group includes a terrestrial network group; and/or
optionally, an RSRP difference threshold and/or an RSRQ difference threshold for comparison of RSRP and/or RSRQ between a serving cell and different types of neighbouring cell groups

In an example according to the present disclosure, a UE receives periodic information (for example, system information) sent by a base station at a first time T1, thereby receiving configuration of a serving cell and system information of a neighbouring cell group.

The UE applies different cell reselection processes according to different types of serving cells and different types of cells in the neighbouring cell list group.

The UE is in an idle state and camps on a cell 1. At the first time T1, the UE receives a system information block (SIB) sent by the base station, and the type of the serving cell is type 1 (for example, a non-terrestrial network). The system information contains at least two neighbouring cell list groups.

The system information of each cell in group 1 contains a reference location and a cell radius of the cell.

The system information of each cell in group 2 contains a reference location and a list of RSRP thresholds or a list of distance thresholds of the cell, and optionally, a beam type of the cell. Since cells in group 2 are of the same type as the serving cell, the measurement process for the cells in group 2 can refer to traditional technologies and will not be described in detail here.

In the following description, measuring, by the UE, a neighbouring cell in a normal mode refers to Table 1.

TABLE 1
The values of the number of DRX cycles in the table are examples and may be
modified to other values appropriately

| | | | Tₑᵥₐₗᵤₐₜₑ [s] |
|---|---|---|---|
| DRX cycle | T_{detect} [s] (number | Tₘₑₐₛᵤᵣₑ [s] (number | (number of DRX |
| length [s] | of DRX cycles) | of DRX cycles) | cycles) |
| 0.32 | $2.56 \times M 2 {( 8 \times M 2 )}^{Note 1}$ | $0.32 \times M 3 {( 1 \times M 3 )}^{Note 1}$ | $0.96 \times M 4 {( 3 \times M 4 )}^{Note 1}$ |
| 0.64 | 5.12 (8) | 0.64 (1) | 1.92 (3) |
| 1.28 | 8.96 (7) | 1.28 (1) | 3.84 (3) |
| 2.56 | 58.88 (23) | 2.56 (1) | 7.68 (3) |

Note 1:
When SMTC <= 40 ms, M2 = M3 = M4 = 1; and when SMTC > 40 ms, M2 = 2, M3 = M4 = 2.5

The UE may evaluate whether a new detectable cell meets a reselection criteria within the time T_{detect} (in Table 1).

The UE may measure SS-RSRPs/SS-RSRQs at least every Tₘₑₐₛᵤᵣₑ (in Table 1).

For a cell that has been detected but has not been reselected to, the UE may evaluate that the cell meets the reselection criteria within Tₑᵥₐₗᵤₐₜₑ (in Table 1).

The intra-frequency or inter-frequency measurement on neighbouring cells performed by the UE in the relaxed mode, means that:

The above-mentioned T_{detect} or Tₘₑₐₛᵤᵣₑ or Tₑᵥₐₗᵤₐₜₑ is replaced by the above-mentioned normal measurement time or period multiplied by a multiple factor K or fixed values greater than the corresponding values in the normal mode are defined.

At the first time T1, the UE receives periodic information (for example, a system information block (SIB)) sent from the base station and determining whether to perform measurement on a neighbouring cell, including at least one of the following examples.

In one example, the cell may stop time of the serving cell for the coverage area.

In one example, if a reference location and/or time information of the reference location of the serving cell is received at the first time T1, then the UE calculates a distance from a UE location to the reference location of the serving cell at the first time T1. If a condition 1 is met at the first time T1, then the UE may not measure the neighbouring cells in group 1. Condition 1: The distance from the UE location to the reference location of the serving cell at the first time T1 is less than the first distance threshold, and a distance from a reference location of a neighbouring cell in the group 1 to the reference location of the serving cell plus a cell radius of the neighbouring cell in the group 1 is less than the first distance threshold. Otherwise, the UE performs measurement of the neighbouring cell in a normal mode. If a condition 2 is met at the first time T1, then the UE perform a relaxed measurement on the cells in the group 1. Condition 2: The distance from the UE location to the reference location of the serving cell at the first time T1 is less than the first distance threshold, and the distance from the reference location of the neighbouring cell in the group 1 to the reference location of the serving cell plus the cell radius of the neighbouring cell in the group 1 is less than a third distance threshold. Otherwise, the UE performs measurement of the neighbouring cell in a normal mode.

In one example, the cells in the group 1 are divided into several subgroups according to distances from the reference location of the serving cell, and each subgroup corresponds to a different measurement multiple factor. The measurement time for each subgroup is obtained by multiplying basic time (T_{detect} or Tₘₑₐₛᵤᵣₑ or Tₑᵥₐₗᵤₐₜₑ) in Table 1 by this multiple factor. For example, if the distance from a reference location of a cell in a subgroup 1 to the reference location of the serving cell plus a radius of the cell in the subgroup 1 is within the first distance threshold multiplied by 4, then the multiple factor corresponding to the cell in the subgroup 1 may be 2, and the measurement time corresponding to the subgroup 1 may be each measurement time in table 1 multiplied by 2; if the distance from a reference location of a cell in a subgroup 2 to the reference location of the serving cell plus a radius of the cell in the subgroup 1 is within the first distance threshold multiplied by 2, then the multiple factor corresponding to the cell in the subgroup 2 may be 1.5, and the measurement time corresponding to the subgroup 2 may be each measurement time in table 1 multiplied by 1.5, and so on. The beneficial effect for doing this is that in wide area coverage, the UE measures a neighbouring cell more accurately according to the location where it is located, improving energy saving of the UE and the accuracy of cell reselection. The values in the above examples are examples and may be changed to other values as appropriate without departing from the scope of the present disclosure.

In one example, the UE measures a moving direction and a moving speed of the UE, and a rule may be added for cell reselection. For example, the rule is: if the UE has performed M measurements for a certain cell in the group 1 or passed through the cell in location during a period of T_{duration} (the T_{duration} may be configuration sent by the base station or a preset value), then the UE may perform a relaxed measurement on the neighbouring cell.

In one example, if the base station is configured with a group priority, then the UE that receives the system information prioritizes measurement of the cells of the group type indicated by the group priority, ignoring the aforementioned distance comparison. For example, if a terrestrial cell group is configured as prioritized through the group priority, then measurement of a terrestrial cell is prioritized over a non-terrestrial cell, even if the non-terrestrial cell is closer in distance.

According to an example embodiment of the present disclosure, the UE is in idle state and camps on a cell 1. At time T1, the UE receives a system information block (SIB) sent by the base station, and the type of the serving cell is type 2 (for example, a terrestrial network). The system information contains at least two neighbouring cell list groups.

The system information for each cell in a group 1 contains a list of RSRP thresholds and/or a list of RSRQ thresholds for the cell.

The system information for each cell in a group 2 contains a beam type and a list of distance thresholds for the cell.

The UE calculates the RSRP and/or RSRQ of the serving cell at the first time, and if the calculated RSRP and/or RSRQ is higher than the RSRP and/or RSRQ threshold of the serving cell for not measuring a neighbouring cell, then measurement of the neighbouring cell is not performed, otherwise, the neighbouring cell is measured according to Table 1 (T_{detect}, Tₘₑₐₛᵤᵣₑ, Tₑᵥₐₗᵤₐₜₑ, and any combination thereof).

More specifically, for each neighbouring cell in the group 2, the UE calculates a distance from a UE location to a reference location of the neighbouring cell at the first time T1. If the distance from the UE location to the reference location of the neighbouring cell at the first time T1 is less than or equal to a second distance threshold, then the UE initiates a normal neighbouring cell measurement for the neighbouring cell in the group 2. Otherwise, the UE may not measure the neighbouring cell.

If the serving cell is configured with a group priority and the group priority is included in the system information, then the UE receiving the system information prioritizes reselection of a cell of a group type indicated by the group priority, ignoring the comparisons of the RSRPs (and/or RSRQs) and the comparisons of the distances mentioned above. For example, if a terrestrial cell group is configured as prioritized through the group priority, then reselection of a terrestrial cell is still prioritized, even if a non-terrestrial cell is closer in distance. If a non-terrestrial cell group is configured as prioritized through the group priority, reselection of a non-terrestrial cell is still prioritized, even if the RSRP (and/or RSRQ) of a terrestrial cell is higher.

In another embodiment, the base station configures an RSRP difference threshold and/or an RSRQ difference threshold, and the UE performs a cell reselection based on the RSRP difference threshold and/or the RSRQ difference threshold, so as to improve the accuracy of cell reselection when the RSRP and/or RSRQ difference between a non-terrestrial cell and a terrestrial cell is large.

This embodiment may be used when a cell group 1 and/or a cell group 2 are configured.

For example, in an intra-frequency measurement,
(1) when a rangeToBestCell is not configured:
the UE may re-select a cell, with the highest-rank, that at least higher than the RSRP difference threshold and/or the RSRQ difference threshold; and/or
(2) when a rangeToBestCell is configured:
the UE may re-select a cell with the highest number of beams above an absolute threshold (absThreshSS-BlocksConsolidation), and a R value of the cell may be within the range rangeToBestCell of a R value of the cell with the highest rank:
   (i) if there are multiple such cells, then the UE re-selects the cell with the highest rank of these cells:
      (a) if the serving cell is also among them, then the cell is at least higher than the RSRP difference threshold and/or the RSRQ difference threshold.

FIG. 4 illustrates an example of a cell reselection in a convergence network according to various embodiments of the present disclosure. In the example embodiment according to the present disclosure, as shown in FIG. 4, a serving cell is a non-terrestrial network cell, that is, a serving cell of a satellite 1, a beam type of the satellite 1 is a moving beam, and in a neighbouring cell list group, a group 1 is a terrestrial network cell group that includes N1 cells, and a group 2 is a non-terrestrial network cell group that includes N2 cells. The system information of each cell in the group 1 contains a reference location and a cell radius of the cell.

The system information for each cell in the group 2 contains a beam type and a list of distance thresholds for the cell. Since cells in the group 2 are of the same type as the serving cell, the measurement process for the cells in the group 2 can refer to traditional technologies and will not be described in detail here.

In an embodiment, a UE receives periodic information (such as a system information block (SIB)) sent by a base station at a first time T1. If time information of a reference location of a serving cell is received at the first time T1, then the UE calculates a distance from a UE location to the reference location of the serving cell at the first time T1. If the distance from the UE location to the reference location of the serving cell at the first time T1 is less than a first distance threshold, and a distance from a reference location of a cell of the group 1 to the reference location of the serving cell plus a radius of the cell of the group 1 is less than the first distance threshold, then the UE may not perform neighbouring cell measurement on the cell in the group 1. Otherwise, the UE performs neighbouring cell measurement according to measurement time or period.

If the first distance threshold is configured in the SIB, then the neighbouring cell measurement is a normal measurement. If a third distance threshold is configured in the SIB, then the neighbouring cell measurement is a relaxed measurement. The threshold for the above distance comparison is the third distance threshold. Optionally, the UE measures a moving direction and a moving speed of the UE, calculates an expected reference location of the serving cell at a second time T2, compares a distance from a UE location to the expected reference location of the serving cell at the second time T2, and a relationship between the UE location and a location of a cell in the group 1, and if a condition is met, then the UE does not measure the neighbouring cell. An example of meeting the condition is: the distance from the UE location to the reference location of the serving cell is less than the first distance threshold and a distance from a reference location of a cell of the group 1 to the reference location of the serving cell plus a radius of the cell of the group 1 is less than the first distance threshold.

FIG. 5 illustrates another example of a cell reselection in a convergence network according to various embodiments of the present disclosure. In yet another example embodiment according to the present disclosure, as shown in FIG. 5, a serving cell is a terrestrial network cell, and in a neighbouring cell list group, a group 1 is a terrestrial network cell group that includes N1 cells, and a group 2 is a non-terrestrial network cell group that includes N2 cells.

The system information for each cell in the group 1 contains a list of RSRP thresholds and/or a list of RSRQ thresholds for the cell. Since cells in the group 1 are of the same type as the serving cell, the measurement process for the cells in the group 1 can refer to traditional technologies and will not be described in detail here.

The system information for each cell in the group 2 contains a beam type and a list of distance thresholds for the cell.

The UE calculates a RSRP and/or a RSRQ of the serving cell at the first time, and if the calculated RSRP and/or RSRQ is higher than a RSRP and/or RSRQ threshold of the serving cell for not measuring a neighbouring cell, the neighbouring cell is not measured, otherwise, the neighbouring cell is measured.

More specifically, for each neighbouring cell in the group 2, the UE calculates a distance from a UE location to a reference location of the neighbouring cell at the first time T1. If the distance from the UE location to the reference location of the neighbouring cell at the first time T1 is less than a distance threshold (a second threshold) for the neighbouring cell in the group 2 for performing the neighbouring cell measurement, then the UE initiates the neighbouring cell measurement for the neighbouring cell in the group 2 and performs the neighbouring cell measurement according to a minimum measurement time or period. Otherwise, the UE does not perform the neighbouring cell measurement.

In yet another example embodiment according to the present disclosure, a serving cell is a non-terrestrial network cell, that is, a serving cell of a satellite 1, a beam type of the satellite 1 is a terrestrial fixed beam, and in a neighbouring cell list group, a group 1 is a terrestrial network cell group that includes N1 cells, and a group 2 is a non-terrestrial network cell group that includes N2 cells.

The system information of each cell in the group 1 contains a reference location and a cell radius of the cell.

The system information for each cell in the group 2 contains a beam type and a list of distance thresholds for the cell.

A UE receives periodic information (such as a system information block (SIB)) sent by a base station at a first time T1. If the SIB received at the first time T1 contains time information of a reference location of the serving cell, then the UE calculates a distance from a UE location to the reference location of the serving cell at the first time T1. If the distance from the UE location to the reference location of the serving cell at the first time T1 is less than a first distance threshold, and a distance from a reference location of a cell of the group 1 to the reference location of the serving cell plus a radius of the cell of the group 1 is less than the first distance threshold, then the UE may not perform neighbouring cell measurement on the cell in the group 1. Otherwise, the neighbouring cell measurement is performed according to a minimum measurement time or period (for example, T_{detect}, Tₘₑₐₛᵤᵣₑ, Tₑᵥₐₗᵤₐₜₑ, and any combination thereof in Table 1).

In another example embodiment according to the present disclosure, a serving cell is a terrestrial network macro cellular cell, and in a neighbouring cell list group, a group 1 is a terrestrial network pico cell group that includes N1 cells, and a group 2 is a terrestrial network macro cell group that includes N2 cells.

The system information of the serving cell contains a list of RSRP and/or RSRQ thresholds and a reference location and a location distance threshold for the serving cell.

The system information of each cell in the group 1 contains a reference location and a cell radius of the cell.

The system information for each cell in the group 2 contains a reference location and a location distance threshold of the cell. Since cells in the group 2 are of the same type as the serving cell, the measurement process for the cells in the group 2 can refer to traditional technologies and will not be described in detail here.

At a first time T1, the UE receives periodic information (for example, a system information block (SIB)) sent by a base station, and the UE calculates an RSRP and/or RSRQ of the serving cell at the first time, and if the calculated RSRP and/or RSRQ is higher than a RSRP and/or RSRQ threshold of the serving cell for not performing neighbouring cell measurement, the neighbouring cell measurement may not be performed. Otherwise, the neighbouring cell measurement is performed according to a minimum measurement time or period (for example, T_{detect}, Tₘₑₐₛᵤᵣₑ, Tₑᵥₐₗᵤₐₜₑ in Table 1, and any combination thereof).

The UE receives periodic information (such as a system information block (SIB)) sent by a base station at a first time T1. If time information of a reference location of a serving cell is received at the first time T1, the UE calculates a distance from a UE location to the reference location of the serving cell at the first time T1. If the distance from the UE location to the reference location of the serving cell at the first time T1 is less than a first distance threshold, and a distance from a reference location of a cell of the group 1 to the reference location of the serving cell plus a radius of the cell of the group 1 is less than the first distance threshold, then the UE may not perform neighbouring cell measurement on the cell in the group 1. Otherwise, the measurement of the neighbouring cell is performed.

FIG. 6 illustrates a flowchart of a UE for performing a cell reselection in a convergence network according to various embodiments of the present disclosure.

As shown in FIG. 6, in step 610, the UE may receive first information from a base station of a serving cell of a first type. In some embodiments, the first information may include location-related information of the serving cell and information of a neighbouring cell of a second type.

In step 630, the UE may perform a measurement of a neighbouring cell of the first type and/or a neighbouring cell of the second type based on a UE location and the location-related information of the serving cell.

In the example embodiment, description of the preceding embodiments can be referred for the specific content of the first information and the process by which UE performs the measurement of the neighbouring cell of the second type different from the first type, which will not be described again here.

Those skilled in the art should understand that “user equipment” or “UE” herein may refer to any terminal capable of wireless communication, including but not limited to a mobile phone, a cellular phone, a smart phone, a personal digital assistants (PDA), a portable computer, an image capture device such as a digital camera, a gaming device, a music memory and playback device, and any portable unit or terminal capable of wireless communication, or Internet facilities allowing wireless Internet access and browsing.

As used herein, the term “base station” (BS) or “network equipment” may refer to an eNB, an eNodeB, a NodeB or a base station transceiver (BTS) or a gNB according to the technology and terminology used.

The “memory” herein may be any type suitable for the technical environment herein, and may be implemented using any suitable data memory technology, including but not limited to a semiconductor-based memory device, a magnetic memory device and system, an optical memory device and system, a fixed memory and a removable memory.

The processor herein may be any type suitable for the technical environment herein, including but not limited to one or more of the following: a general-purpose computer, a specialized computer, a microprocessor, a digital signal processor DSP, and a processor based on a multicore processor architecture.

The above provides only preferred embodiments of this disclosure and is not intended to limit this disclosure. Any modification, equivalent replacement, improvement, and the like made within the spirit and principle of this disclosure shall fall within the patentable scope of this disclosure.

Those skilled in the art may understand that this disclosure relates to devices for performing one or more of the operations described in this disclosure. These devices can be specifically designed and manufactured for the desired purpose, or they can also include known devices found in general-purpose computers. These devices have computer programs stored within them, which are selectively activated or reconstructed. Such computer programs may be stored in a device (e.g., a computer) readable medium or stored in any type of media suitable for storing electronic instructions and separately coupled to a bus, wherein the computer-readable medium includes, but is not limited to, any type of disk (including a floppy disk, a hard disk, an optical disk, a CD-ROM, and a magneto-optical disk), a ROM (read-only memory), a RAM (random access memory), an EPROM (erasable programmable read-only memory), an EEPROM (electrically erasable programmable read-only memory), a flash memory, a magnetic card or a light card. That is, readable medium includes any medium that stores or transmits information by a device (e.g., a computer) in a form capable of being readable.

Those skilled in the art may understand that each block in these structure diagrams and/or block diagrams and/or flow diagrams and combinations of blocks in these structure diagrams and/or block diagrams and/or flow diagrams may be implemented with computer program instructions. Those skilled in the art may understand that these computer program instructions may be provided to a general purpose computer, a specialized computer or another processor with other programmable data processing methods for implementation, thereby performing the solution indicated in one or more blocks in structure diagram and/or block diagram and/or flow diagram disclosed in this disclosure by a computer or a processor with other programmable data processing methods.

Those skilled in the art can recognize that this disclosure can be implemented in other specific forms without changing the technical idea or essential features of this disclosure. Therefore, it should be understood that the above embodiments are merely examples and are not limiting. The scope of this disclosure is defined by the appended claims, rather than the detailed description. Therefore, it should be understood that all modifications or changes and their equivalents derived from the meaning and scope of the appended claims are within the scope of this disclosure.

In the above embodiments of the present disclosure, all operations and steps may be selectively performed or may be omitted. Furthermore, the operations and steps in each embodiment need not be performed sequentially, and the order of operations and steps may vary.

While this disclosure has been shown and described with reference to various embodiments of this disclosure, those skilled in the art may appreciate that, without departing from the spirit and scope of this disclosure as defined by the appended claims and their equivalents, variations may be made to the form and detail thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
receiving, from a base station of a serving cell of a first type, first information including at least one of location-related information of the serving cell or information of a neighbouring cell of a second type; and
measuring the neighbouring cell of the second type based on at least one of a terminal location or the location-related information of the serving cell.

2. The method of claim 1, further comprising:
measuring a neighbouring cell of the first type; and
reselecting a cell based on a measurement result of the neighbouring cell of the first type and a measurement result of the neighbouring cell of the second type,
wherein the first information further comprises information of the neighbouring cell of the first type.

3. The method of claim 1, wherein the location-related information of the serving cell comprises a reference location of the serving cell, and
wherein measuring the neighbouring cell of the second type based on a UE location and the location-related information of the serving cell further comprises determining whether to measure the neighbouring cell of the second type based on a distance from the UE location to the reference location of the serving cell.

4. The method of claim 1, wherein the first information further comprises location-related information of the neighbouring cell of the second type, and
wherein measuring the neighbouring cell of the second type based on a UE location and the location-related information of the serving cell comprises measuring the neighbouring cell of the second type based on the UE location, the location-related information of the serving cell, and the location-related information of the neighbouring cell of the second type.

5. The method of claim 4, wherein the location-related information of the serving cell comprises a reference location of the serving cell,
wherein the location-related information of the neighbouring cell of the second type comprises a reference location of the neighbouring cell of the second type, and
wherein measuring the neighbouring cell of the second type based on the UE location and the location-related information of the serving cell comprises determining whether to measure the neighbouring cell of the second type based on a distance from the UE location to the reference location of the serving cell, and a distance from the reference location of the serving cell to the reference location of the neighbouring cell of the second type.

6. A method performed by a base station in a wireless communication system, the method comprising:
transmitting, from a serving cell of a first type to a terminal), first information including at least one of location-related information of the serving cell or information of a neighbouring cell of a second type; and
receiving, from the terminal, an uplink transmission signal,
wherein the location-related information of the serving cell is used for measurement of the neighbouring cell of the second type.

7. The method of claim 6, further comprising obtaining a measurement result of the neighbouring cell of the first type and a measurement result of the neighbouring cell of the second type are used for a reselection of a cell,
wherein the first information further comprises information of the neighbouring cell of the first type.

8. The method of claim 6, wherein the location-related information of the serving cell comprises a reference location of the serving cell, and
wherein the reference location of the serving cell is used for measurement of the neighbouring cell of the second type.

9. The method of claim 6, wherein the first information further comprises location-related information of the neighbouring cell of the second type, and
wherein the location-related information of the neighbouring cell of the second type is used for measurement of the neighbouring cell of the second type.

10. The method of claim 9, wherein the location-related information of the serving cell comprises a reference location of the serving cell,
wherein the location-related information of the neighbouring cell of the second type comprises a reference location of the neighbouring cell of the second type, and
wherein the reference location of the serving cell and the reference location of the neighbouring cell of the second type are used for measurement of the neighbouring cell of the second type.

11. A terminal in a wireless communication system, the terminal comprising:
a transceiver; and
at least one processor configured to:
receive, from a base station of a serving cell of a first type, first information including at least one of location-related information of the serving cell or information of a neighbouring cell of a second type, and
measure the neighbouring cell of the second type based on at least one of a terminal location or the location-related information of the serving cell.

12. The terminal of claim 11, wherein the at least one processor is further configured to:
measure a neighbouring cell of the first type; and
reselect a cell based on a measurement result of the neighbouring cell of the first type and a measurement result of the neighbouring cell of the second type,
wherein the first information further comprises information of the neighbouring cell of the first type.

13. The terminal of claim 11, wherein the location-related information of the serving cell comprises a reference location of the serving cell, and
wherein measuring the neighbouring cell of the second type based on a UE location and the location-related information of the serving cell further comprises determining whether to measure the neighbouring cell of the second type based on a distance from the UE location to the reference location of the serving cell.

14. The terminal of claim 11, wherein the first information further comprises location-related information of the neighbouring cell of the second type, and
wherein measuring the neighbouring cell of the second type based on a UE location and the location-related information of the serving cell comprises measuring the neighbouring cell of the second type based on the UE location, the location-related information of the serving cell, and the location-related information of the neighbouring cell of the second type.

15. The terminal of claim 14, wherein the location-related information of the serving cell comprises a reference location of the serving cell,
wherein the location-related information of the neighbouring cell of the second type comprises a reference location of the neighbouring cell of the second type, and
wherein measuring the neighbouring cell of the second type based on the UE location and the location-related information of the serving cell comprises determining whether to measure the neighbouring cell of the second type based on a distance from the UE location to the reference location of the serving cell, and a distance from the reference location of the serving cell to the reference location of the neighbouring cell of the second type.

16. Abase station in a wireless communication system, the base station comprising:
a transceiver; and
at least one processor configured to:
transmit, from a serving cell of a first type to a terminal), first information including at least one of location-related information of the serving cell or information of a neighbouring cell of a second type, and
receive, from the terminal, an uplink transmission signal,
wherein the location-related information of the serving cell is used for measurement of the neighbouring cell of the second type.

17. The base station of claim 16, wherein the at least one processor is further configured to:
obtain a measurement result of the neighbouring cell of the first type and a measurement result of the neighbouring cell of the second type are used for a reselection of a cell,
wherein the first information further comprises information of the neighbouring cell of the first type.

18. The base station of claim 16, wherein the location-related information of the serving cell comprises a reference location of the serving cell, and
wherein the reference location of the serving cell is used for measurement of the neighbouring cell of the second type.

19. The base station of claim 16, wherein the first information further comprises location-related information of the neighbouring cell of the second type, and
wherein the location-related information of the neighbouring cell of the second type is used for measurement of the neighbouring cell of the second type.

20. The base station of claim 19, wherein the location-related information of the serving cell comprises a reference location of the serving cell,
wherein the location-related information of the neighbouring cell of the second type comprises a reference location of the neighbouring cell of the second type, and
wherein the reference location of the serving cell and the reference location of the neighbouring cell of the second type are used for measurement of the neighbouring cell of the second type.
